(19) United States
(12) Patent Application Publication
(10) Pub. No.: US 2004/0059886 A1
(43) Pub. Date: Mar. 25, 2004

(54) Filtering of a data stream in a telecommunications network

(76) Inventors: Sami Karhulahti, Espoo (FI); Markku Ruuskanen, Porvoo (FI); Ari Hurtta, Espoo (FI); Antti Tuominen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/362,633

(22) PCT Filed: Jun. 28, 2001
(86) PCT No.: PCT/FI01/00615

(30) Foreign Application Priority Data
Aug. 25, 2000 (FI) 20001883

(51) Int. Cl. G06F 12/00

(52) U.S. Cl. 711/167; 711/168; 711/118

(57) ABSTRACT

A method and a system for filtering a data stream in a telecom-munications network. The objective of the invention is to provide a filtering mechanism for a data stream whereby the amount of data in the stream is reduced without using compression and with a minimal loss of channel in-formation content. The system comprises two logically different memories. The first memory (201) is used to store channel control information and the second memory (202) to store channel information according to the control channel information stored in the first memory. The fill rate of the first memory is monitored and the content of the second memory is checked by the control unit (200).

### FIELD OF THE INVENTION

The present invention relates generally to the filtering of a data stream in a telecommunications network.

### BACKGROUND OF THE INVENTION

A switching network is one of the most important components in digital exchanges. In the worst case the failure of the switching network can paralyze the telephone services of a large number of subscribers. A control unit (usually a computer) of the system is informed by an alarm if there is a failure in the switching network. In traditional solutions each received alarm is also acknowledged. No problems appear as long as the control unit has enough time to process the alarms.

FIG. 1 illustrates a block diagram showing a method, which is traditionally used to process alarms, for example in association with a switching network of a digital exchange.

A full data stream arrives from a switching network (not shown in FIG. 1) at memory 100. The memory is usually a FIFO (First In First Out) buffer memory from which data is read in the same order as it arrived at the memory. A computer 101 reads the content of the buffer memory, processes the data and, depending on the fault, a test run in the switching network is activated for localizing the fault, for example. The computer also monitors the fill rate of the memory.

A major problem arises when a failure burst takes place abruptly in the data stream. In other words, a lot of alarms can arrive from the switching network at a same time, e.g. because of damage in the switching network. As long as all incoming alarms are accepted, there is a risk that the memory will overflow and, as a result, the whole system will become paralyzed and relevant information will be lost. Another problem is that each message received is acknowledged by the control unit. This can lead to a situation where a lot of time is used to receive and acknowledge alarms, even the same alarms many times.

### SUMMARY OF THE INVENTION

The objective of the invention is to provide a filtering mechanism for a data stream, whereby an amount of data in a stream is reduced without using compression and with minimal loss of channel information content.

The objective is achieved through a method and a system which are characterized by what is stated in the independent claims. Preferred embodiments of the invention are presented in the dependent claims.

The system substantially differs from the known solutions in that, instead of one memory, the system comprises two logically different memories.

The first memory is used to store channel control information, whereas the second is used to store channel information according to the control information stored in the first memory and to a predefined limiting factor. The content of the second memory is checked by a control unit and the fill rate of the first memory can be used as the predefined limiting factor.

In case of a lot of alarms coming from a certain channel, it is highly probable that the alarms are received from several sub-channels of that channel. Then, the system starts to limit the data flow by deleting information that is most likely irrelevant, when a predetermined external limiting condition is met. The purpose is to minimize the processing of irrelevant information and to process the most relevant part of the information as efficiently as possible. The advantage of the method comes out best when there exists redundancy in the channels.

One advantage of the method is that it helps to achieve a fast and reliable way to handle data coming from a system, e.g. from a switching network, which might suddenly cause a large number of alarms to be processed at the same time.

Another advantage is that the same data is not stored many times into the memory. This reduces the amount of the data to be processed.

### BRIEF DESCRIPTION OF THE DRAWINGS

The invention is described more closely with reference to the accompanying drawings, in which

FIG. 1 illustrates a known system for processing alarms;

FIG. 2 illustrates a channel based adaptive loss filtering of a data stream in accordance with the invention,

FIG. 3 is a flow chart illustrating the method,

FIG. 4 is another flow chart illustrating the method, and

FIG. 5 illustrates a data stream.

### DETAILED DESCRIPTION OF THE INVENTION

The present invention can be applied to any telecommunication network. As an example, the invention will be described in more detail in association with the switching network in a conventional TDM network. The switch including the switching network is typically a telephone exchange.

In conventional TDM (Time Division Multiplexing) networks, data is transmitted as a bit or symbol stream in time slots, each containing a certain number of bits, typically eight. In conventional PCM systems the bits in any single time slot are all reserved to one and the same channel. For example, in the European 2048 kbit/s basic multiplexing system the transmission frame comprises a total of 30 voice channels, each with a capacity of 64 kbit/s. In the corresponding U.S. system, the number of channels in a frame is 24 and the transmission rate of the system is 1544 kbit/s.

The basic principles of the method for providing redundancy for a switching network are described in the applicant's earlier Patent Application F1980516, not published at the date of the filing of this application. The idea of that method is to double a switching network (or any other switching element) and to test the operation of the switching networks by comparing data in corresponding output channels, preferably on a continuous basis. A critical moment comes up when the corresponding connections in both the switching networks are not switched exactly simultaneously: the data in these networks may differ momentarily. If there is a slight discrepancy between one or more output channel pairs, a burst of failure information may erroneously indicate faults in several PCM lines.

In the present invention, the data stream to be processed is divided into blocks or other units, which are on at least two different levels of hierarchy. The aggregate stream can be divided into three levels for example so that the highest level comprises multi-blocks, each of which is further divided into smaller units defined as blocks, which are further divided into sub-blocks, in the following way (FIG. 5):

STREAM=MULTI-BLOCK_{—}0((BLOCK_{—}0(sub0, sub1, sub2, . . . )BLOCK_{—}1(sub0, sub1, sub2, . . . ) . . . )MULTI-BLOCK_{—}1((BLOCK_{—}0(sub0,sub1,sub2, . . . )BLOCK_{—}1(sub0,sub_{—}1,sub2, . . . ) . . . ) . . .

In a preferred embodiment the division into mufti-blocks is performed on a PCM line basis. The blocks may then represent the channels in a line, where as each sub-block describes the status of an individual time slot on the current PCM line.

The blocks below are therefore called channels and the sub-blocks are called sub-channels.

Normally, the sub-channels do not carry information which is to be processed further. Thus, a status of each sub-channel is usually determined as irrelevant. However, when a failure is detected in the current PCM line it is highly probable that several sub-channels within one channel have a valid status and further processing of the information of the sub-channels is required. On certain occasions, the information in some sub-channels can be dependent on each other, i.e. there is a correlation between these sub-channels. The purpose of the invention is to process the most relevant information as soon as possible and to stop further processing of irrelevant information. Therefore, when a correlation exists between the sub-channels, there is little or no use to process all the sub-channels repeatedly. On the contrary, it is often enough to analyze only part of the data.

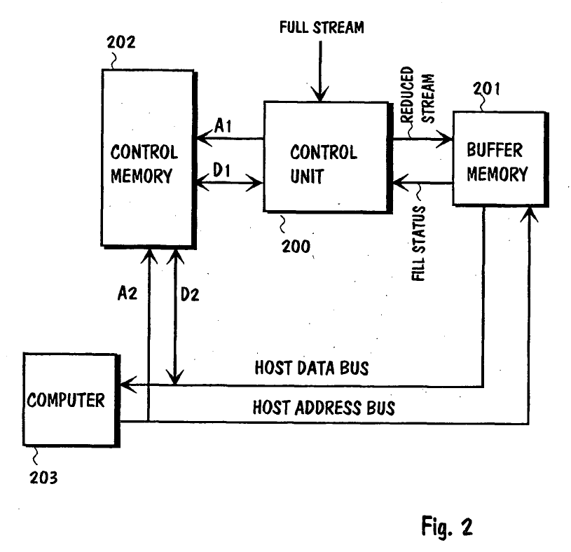

FIG. 2 shows an example of one implementation of the system according to the invention. In this example the implementation is used to ensure that any faults occurring in the switching network are processed as quickly as possible. However, especially when there is congestion, they are processed in such a way that the most relevant information is processed first and the less relevant afterwards, if ever.

The main parts of the system are a control unit 200 and two memories, a buffer memory 201 and a control memory 202. In addition, the system includes a control computer 203 for processing the alarms.

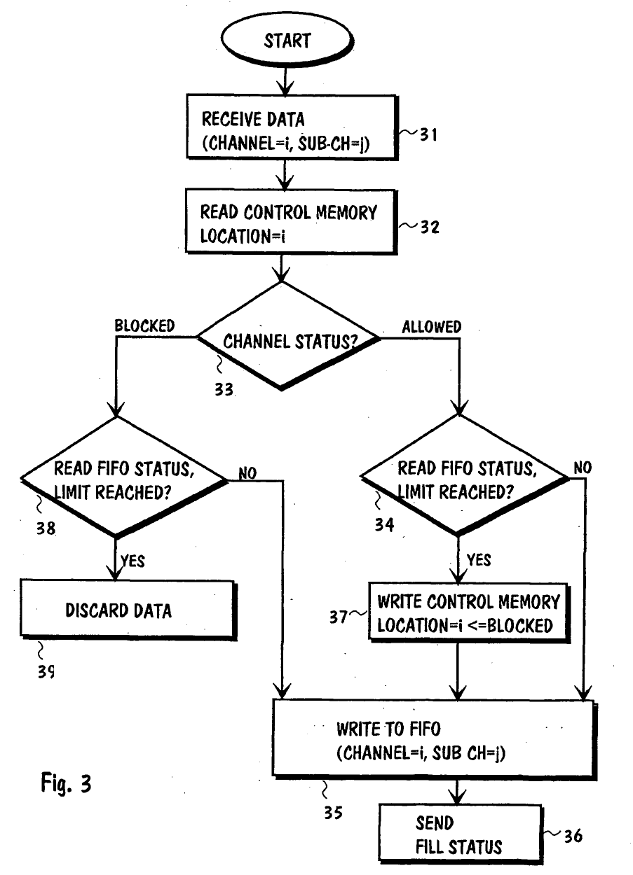

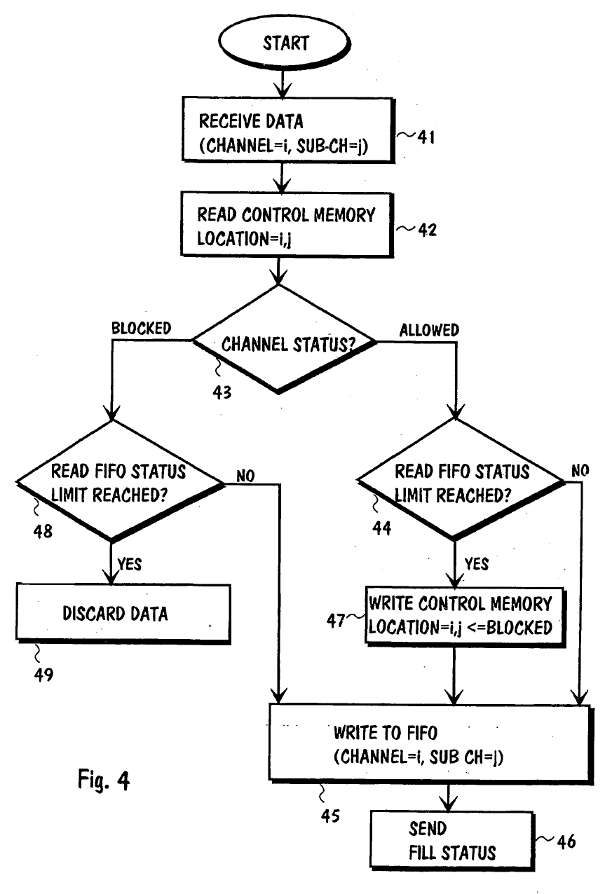

FIGS. 3 and 4 are flowcharts illustrating the steps of the method according to the invention. In the following, a solution is described in detail with reference to the figures.

In an ideal case, the two switching networks operate exactly synchronously with each other: they switch exactly at the same time.

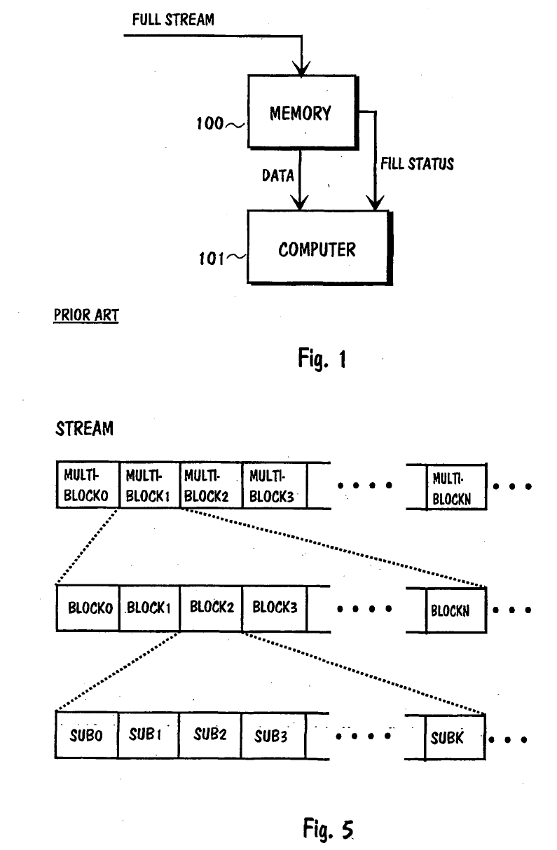

When there is no congestion, i.e. the number of alarms is low, the system operates similarly as the prior art system shown in FIG. 1. That is, the control unit is transparent to the alarms when they are transmitted through it into the buffer memory 201, for example a FIFO-memory (First In First Out), where the alarms are stored before the actual processing. The control computer 203 requests data from the buffer memory 201 by sending a read signal via the host address bus. Since a FIFO-memory is concerned, the data is processed in the order of arrival. The data is sent from the FIFO-memory to the control computer via the host data bus and the data is processed in the control computer.

In a case where a slight difference occurs between the switching moments of the switching networks, the contents of the corresponding output channels are not identical. This does not necessarily mean that one of the switching networks is operating incorrectly, but the corresponding connections are updated slightly asynchronously. Normally, synchronization is adjusted by a time filtering. However, the time filtering does not necessarily function ideally. As a consequence, there might occasionally be a burst of failures which are of no consequence. In this kind of situation a full stream composed mainly of alarms of no consequence, arrives from the switching network (or another switching element) to the control unit 200.

In the following two examples situations are examined where the fill rate of the buffer memory is under and above a predetermined level. The limiting condition or fill rate is determined externally e.g. from the control computer.

In the first situation, it is assumed that the fill rate in both memories is initially zero. A full stream including alarms is received into the control unit (step 31 in FIG. 3). The full stream consists of data from 4092 PCM lines, for example. The size of the control memory in this particular example contains then 4092×32 memory locations, where 32 corresponds to the number of channels in a 2 Mbit/s PCM line. Thus, a memory location is reserved for each channel in the full stream. Depending on the implementation and the desired accuracy, the memory can be of various size.

The control unit is informed that both the control memory and the buffer memory are empty, thus, the data is sent directly to the buffer memory (steps 32-33-34-35, in FIG. 3). In response to the received data the buffer memory informs the control unit about its content by sending a fill status signal (step 36, FIG. 3). When needed, the fill status signal can be sent to the control computer, too. As long as the fill rate of the buffer memory remains below the predefined limit, the filtering of the alarms is carried out as described above.

If a burst of failures suddenly arrives via the control unit to the buffer memory, the predefined fill rate limit is exceeded in a moment. The control unit monitors the fill rate of the buffer memory and when a predefined value, 50% for example, is reached (step 34, FIG. 3), the control unit changes its policy, i.e. an automatic restriction is started (step 37, FIG. 3). From now on the control unit controls the incoming alarms according to the state of a special control bit being checked at each of the channels. Instead of sending alarms directly to the buffer memory, the control unit examines first from said control bit whether the alarm is relevant or not relevant (step 32, FIG. 3). In the former case the alarm is sent to the buffer memory and in the latter case the alarm is either discarded, or if the fill rate is lowered again below the predefined value, the alarm is sent to the buffer memory. In the following, we examine these alternatives in more detail.

The control memory is a dual port memory but a one port memory is possible, too. It is assumed that in part of the control memory locations the control bit is set to 1 and the rest it is still in initial state 0. When the full stream including alarms is received into the control unit, the channel status of each channel concerned is monitored (step 32, in FIG. 3). The index of the channel is i and the index of the sub-channel is j, in the figure. The control unit makes a decision on the next action on the basis of the state of the control bit.

For example, if there is an alarm in channel five, the control channel will first check whether the control bit in the memory location corresponding to channel five is set or not. If the control bit is in state 0, the data is passed into the buffer memory (step 33, allowed-alternative in FIG. 3). If the fill rate of the buffer memory is below the predefined limit, the data is sent to the buffer memory (step 34, no-alternative in FIG.3) and stored therein (step 35, in FIG. 3). In response to the received data the fill rate status is sent to the control unit (step 36, FIG. 3). By contrast, if the fill rate is reached, the control bit in the control memory associated with the channel concerned is updated from 0 to 1 by the control unit (step 37, in FIG. 3) and the data is passed into the buffer memory (35 on FIG. 3). Checking and setting the control bit is performed via address bus A1 and data bus D1 (or via address bus A2 and data bus D2) (FIG. 2).

If the control bit of the channel received is in state 1 (step 32, in FIG. 3), it means that the data has already been processed (step 33, blocked-alternative in FIG. 3). The data is then sent into the buffer memory if the fill rate is under the predefined level (step 38, no-alternative in FIG. 3), but if the fill rate has reached or exceeded the predefined level, the data is discarded (step 39, yes-alternative in FIG. 3), because there is no need to process the same data repeatedly.

The control computer can, whenever it will, check the state of each of the channels in the control memory. If it is known, for example, in association with information checked earlier, that something special has been found concerning a particular channel, the control computer has a possibility to check the state of that channel directly via bus A2 (FIG. 2). Further, the control computer has a possibility to modify the state of the control bit via bus D2. In that case it is possible to control an alarm, if required, from such a channel which already has alarmed. A situation like that might be e.g. when a PCM line has physically loosened and the channel associated to that PCM line is sending alarms repeatedly. Another example might be when one of the components of the switching network is damaged. The control computer will give an order to run a test for solving the problem. If it is not possible to solve the problem the control computer reports to the personnel to take care of the problem concerning the alarms.

Address bus Ai and data bus Di (i=1,2) are used together. In FIG. 2 ports 1 and 2 can be directed to the same memory location. It is even possible to read the same memory location simultaneously from the control unit and from the control computer. Naturally, the ports can be directed to different memory locations, too.

A memory location is reserved in the control memory for each of the channels. Due to this repetitive channel information is neither stored nor processed repeatedly. Therefore data from a channel can be discarded if the control information of the corresponding channel indicates that the data has already been processed: Generally, the control memory can have a control bit for each first data block. The control bit controls, whether a second data block is discarded or stored, when the fill rate limit has been reached. The first data block can be shorter than the second data block, i.e. on the basis of a shorter “sample” the system can decide whether a certain longer block of information includes irrelevant information. For example, on the basis of the control information relating to one or more sub-channels the system can decide whether the corresponding channel includes irrelevant information. This embodiment is illustrated in FIG. 4. A policy of this implementation is exactly the same as in FIG. 3, in other words steps 41-49 in FIG. 4 correspond to steps 31-39 in FIG. 3.

Depending on the application environment, the size of the control memory can be determined on the basis of some other criteria. The foregoing examples are based on processing the alarms from the switching networks in a telephone exchange. This does not in any way limit implementation of the filtering system according to the invention to some other environments where there is a need for reducing data flow, especially so that relevant information is not lost.

Even though the invention is described above by referring to examples according to the attached drawings, it is clear that the invention is not limited to situations described in these examples.

It is obvious that the invention can be modified. For example, an advantageous implementation is that a prediction is evolved based on the previous history of the network, i.e. from where possible alarms may appear next. However, this is a quite complex implementation. The control computer can also be replaced by some other intelligent control device.

1. A method for filtering a data stream comprising successive frames,
characterized by
receiving a data stream and storing at least a part of it into a memory,
storing control information for predetermined first data blocks, each first data block being a part of one frame, said information indicating whether a predetermined content of the first data block has been stored earlier into the memory,
monitoring the fill rate of the memory,
checking the control information relating to the first data block being received currently,
dropping a second data block if (1) the fill rate of the memory has exceeded a predetermined level, and (2) the control information indicates that the content of said first data block has been stored earlier, and
storing the second data block otherwise.

2. A method according to claim 1, characterized in that the length of the first data block is smaller than or equal to the second data block.

3. A method according to claim 1, characterized in that the first data block is the same part of a frame as the second data block.

4. A method according to claim 1, characterized by adjusting the predetermined level.

5. A method according to claim 1, characterized in that the second block is a channel.

6. A method according to claim 1, characterized in that the second block includes a plurality of first blocks.

7. A method according to claim 1, characterized in that the second data block is stored into a first memory and the control information is stored into a second memory.

8. A method according to claim 1, characterized by starting the storing of the control information only when the fill rate has exceeded a predetermined limit.

9. A method according to claim 8, characterized in that the limit is smaller than said predetermined level.

10. A method according to claim 8, characterized in that the limit is equal to said predetermined level.

11. A method according to claim 1, characterized in that the receiving, storing, dropping, monitoring and the checking are controlled by a control unit.

12. A system for filtering a data stream comprising successive frames,
characterized in that the system includes
receiving means for receiving a data stream,
memory means for storing at least a part of a data stream,
control means for storing control information for predetermined first data blocks, each first data block being a part of one frame, said information indicating whether a predetermined content of the first data block has been stored earlier into the memory,
monitoring means for monitoring the fill rate of the memory,
checking means for checking the control information relating to the first data block being received currently, and
selective storing means, responsive to the monitoring means and to the checking means, for (a) dropping a second data block if (1) the fill rate of the memory has exceeded a predetermined level, and (2) the control information indicates that the content of said first data block has been stored earlier, and for (b) storing the second data block otherwise.

13. A system according to claim 11, characterized in that the memory means comprises two separate memories, one for storing data belonging to the data stream and another for storing said control information.
